(19) United States
(12) Patent Application Publication
(10) Pub. No.: US 2025/0343704 A1
(43) Pub. Date: Nov. 6, 2025

(54) METHOD, SYSTEM, AND STORAGE MEDIUM FOR CONTROLLING REMOTE CONTROLLER, IN-VEHICLE REMOTE CONTROLLER, AND CONTROL TERMINAL

(71) Applicant: GOERTEK TECHNOLOGY CO., LTD., Qingdao (CN)

(72) Inventor: Bei YANG, Qingdao (CN)

(21) Appl. No.: 19/271,032

(22) Filed: Jul. 16, 2025

Related U.S. Application Data
(63) Continuation of application No. PCT/CN2024/136416, filed on Dec. 3, 2024.

(30) Foreign Application Priority Data
Dec. 5, 2023 (CN) 202311660624.1

(51) Int. Cl. H04L 12/12; B60K 35/10; B60R 16/023; H04W 4/48

(52) U.S. Cl. CPC H04L 12/12; B60K 35/10; B60R 16/023; H04W 4/48

(57) ABSTRACT

The present application discloses a method, a system, and a storage medium for controlling a remote controller, an in-vehicle remote controller and a control terminal. The method for controlling the remote controller is applied to an in-vehicle remote controller, and the in-vehicle remote controller includes: entering a sleep mode in response to a sleep command sent by a control terminal; generating a wake-up command in response to a user operation sensed by the signal monitor; and entering a wake-up mode according to the wake-up command.

### CROSS-REFERENCE TO RELATED APPLICATIONS

This application is a continuation application of International Application No. PCT/CN2024/136416, filed on Dec. 3, 2024, which claims priority to Chinese Patent Application No. 202311660624.1, filed on Dec. 5, 2023. The disclosures of the above-mentioned applications are incorporated herein by reference in their entireties.

### TECHNICAL FIELD

The present application relates to the technical field of remote controller, and in particular to a method, a system, and a storage medium for controlling a remote controller, an in-vehicle remote controller, and a control terminal.

### BACKGROUND

Vehicles are an important means of transportation in people's daily lives today. With the increasing maturity of high-precision positioning technologies such as Ultra Wide Band (UWB) and Bluetooth Angle of Arrival (AOA), in-vehicle remote controllers can meet the interaction needs of passengers in various positions in the vehicle, so that the interaction between users and in-vehicle devices is no longer limited by the user's location, greatly improving the convenience of interaction.

As a portable electronic device, the in-vehicle remote controller is often designed to be small and exquisite, so the size of its supporting battery is required to be small, which limits the battery capacity and leads to poor battery life of the in-vehicle remote controller.

The above contents are only used to assist in understanding the technical solution of the present application and do not constitute an admission that the above contents are prior art.

### SUMMARY

The main objective of the present application is to provide a method, a system, and a storage medium for controlling a remote controller, an in-vehicle remote controller and a control terminal, aiming to solve the technical problem of poor battery life of the in-vehicle remote controller in the conventional method.

In order to achieve the above objective, the present application provides a method for controlling a remote controller, which is applied to an in-vehicle remote controller, the in-vehicle remote controller including: a signal monitor, and the method includes:
entering a sleep mode in response to a sleep command sent by a control terminal;
generating a wake-up command in response to a user operation sensed by the signal monitor; and
entering a wake-up mode according to the wake-up command.

In an embodiment, the entering the wake-up mode according to the wake-up command includes:
increasing a data transmission frequency according to the wake-up command; and
sending a communication connection request to the control terminal based on the increased data transmission frequency.

In an embodiment, the in-vehicle remote controller includes at least one physical button, and the generating the wake-up command in response to the user operation sensed by the signal monitor includes:
monitoring a button signal by the signal monitor, where the button signal is a signal generated after a physical button of the in-vehicle remote controller is triggered; and
in response to the button signal being greater than a preset button signal threshold, determining that the physical button is triggered and generating the wake-up command.

In an embodiment, the in-vehicle remote controller includes at least one inductive sensor configured to monitor whether the in-vehicle remote controller is touched by a user, and the generating the wake-up command in response to the user operation sensed by the signal monitor includes:
monitoring a sensing signal collected by the inductive sensor through the signal monitor; and
in response to the sensing signal being greater than a preset sensing signal threshold, determining that the in-vehicle remote controller is touched by the user and generating the wake-up command.

In an embodiment, the inductive sensor includes at least one of a contact sensor and a non-contact sensor.

In an embodiment, the in-vehicle remote controller is electrically connected to a vehicle and is powered by the vehicle when the vehicle is powered on, and the generating the wake-up command in response to the user operation sensed by the signal monitor includes:
monitoring a charging signal by the signal monitor; and
in response to the charging signal being greater than a preset charging signal threshold, determining that the vehicle is powered on and generating the wake-up command.

The present application further provides a method for controlling a remote controller, which is applied to a control terminal, and the method includes:
in response to a vehicle power-off signal, generating a sleep command; and
sending the sleep command to an in-vehicle remote controller to cause the in-vehicle remote controller to enter a sleep mode, and disconnecting a communication connection with the in-vehicle remote controller.

In an embodiment, after the disconnecting the communication connection with the in-vehicle remote controller, the method further includes:
in response to a vehicle power-on signal, increasing a data scanning frequency; and
searching, based on the increased data scanning frequency, for a communication connection request sent by the in-vehicle remote controller.

The present application further provides a system for controlling a remote controller, including: an in-vehicle remote controller and a control terminal communicated with the in-vehicle remote controller, where:
the in-vehicle remote controller is configured to enter a sleep mode in response to a sleep command sent by the control terminal; generate a wake-up command in response to a user operation sensed by a signal monitor; and enter a wake-up mode according to the wake-up command; and
the control terminal is configured to generate a sleep command in response to a vehicle power-off signal; send the sleep command to the in-vehicle remote controller to cause the in-vehicle remote controller to enter the sleep mode; and disconnect the communication connection with the in-vehicle remote controller.

The present application further provides an in-vehicle remote controller, which includes: a memory, a processor, and a program for controlling a remote controller stored in the memory and executable on the processor, where the program for controlling the remote controller is configured to implement the steps of the above-mentioned method for controlling the remote controller.

The present application further provides a control terminal, which includes: a memory, a processor, and a program for controlling a remote controller stored in the memory and executable on the processor, where the program for controlling the remote controller is configured to implement the steps of the above method for controlling the remote controller.

The present application further provides a storage medium, which is a computer-readable storage medium. A program for controlling a remote controller is stored on the computer-readable storage medium. The program for controlling the remote controller is executed by a processor to implement the steps of the above-mentioned method for controlling the remote controller.

The present application discloses a method for controlling a remote controller, which enables an in-vehicle remote controller to enter a sleep mode at an appropriate time by responding to a sleep command sent by a control terminal, even if the high-power consumption functional modules (for example, a communication module, a high-precision computing module, etc.) of the in-vehicle remote controller all enter a sleep state, thereby reducing the overall power consumption of the in-vehicle remote controller, and retaining a low-power consumption signal monitor in the in-vehicle remote controller to monitor specific signals. Then, in response to a user operation sensed by the signal monitor, a wake-up command is generated, and according to the wake-up command, the wake-up mode is entered, that is, the working state of the in-vehicle remote controller is restored. By reasonably dormant and waking up the in-vehicle remote controller, the overall power consumption of the in-vehicle remote controller is reduced while ensuring user use, thereby increasing the battery life of the in-vehicle remote controller and achieving long-term battery life.

### BRIEF DESCRIPTION OF THE DRAWINGS

FIG. 1 is a schematic structural diagram of an in-vehicle remote controller in a hardware operating environment involved in an embodiment of the present application.

FIG. 2 is a flowchart of a method for controlling a remote controller according to an embodiment of the present application.

FIG. 3 is a flowchart of the method for controlling the remote controller according to an embodiment of the present application.

FIG. 4 is a flowchart of the method for controlling the remote controller according to an embodiment of the present application.

FIG. 5 is a schematic diagram of a scenario involved in an embodiment of the present application.

FIG. 6 is a schematic diagram of a scenario involved in an embodiment of the present application.

FIG. 7 is a schematic diagram of a scenario involved in an embodiment of the present application.

FIG. 8 is a flowchart of the method for controlling the remote controller according to an embodiment of the present application.

The realization of the purpose, functional features and advantages of the present application will be further described with reference to the embodiments and the accompanying drawings.

### DETAILED DESCRIPTION OF THE EMBODIMENTS

It should be understood that the specific embodiments described herein are only used to explain the present application and are not used to limit the present application.

In addition, the descriptions of “first”, “second”, etc. in this application are only for descriptive purposes and cannot be understood as indicating or implying their relative importance or implicitly indicating the number of technical features indicated. Therefore, the features defined as “first” and “second” may explicitly or implicitly include at least one of the features. In addition, “and/or” in the full text includes three solutions. Taking A and/or B as an example, it includes technical solution A, technical solution B, and technical solution that satisfies both A and B; in addition, the technical solutions between the various embodiments can be combined with each other, but it must be based on the ability of ordinary technicians in this field to implement. When the combination of technical solutions is contradictory or cannot be implemented, it should be deemed that such combination of technical solutions does not exist and is not within the scope of protection required by this application.

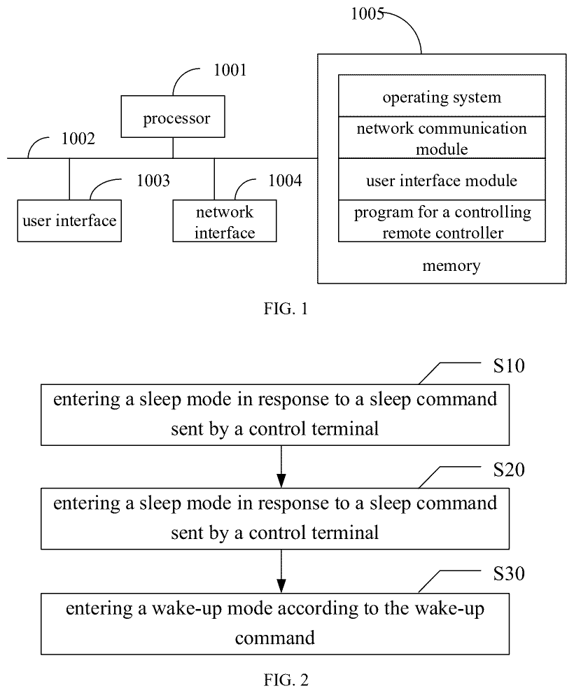

As shown in FIG. 1, which is schematic structural diagram of an in-vehicle remote controller in a hardware operating environment involved in an embodiment of the present application.

As shown in FIG. 1, the in-vehicle remote controller may include: a processor 1001, such as a central processing unit (CPU), a communication bus 1002, a user interface 1003, a network interface 1004, and a memory 1005. The communication bus 1002 is used to realize the connection and communication between these components. The user interface 1003 may include a display, an input unit such as a keyboard, and the user interface 1003 may also include a standard wired interface and a wireless interface. The network interface 1004 may include a standard wired interface and a wireless interface (such as a wireless fidelity (Wi-Fi) interface). The memory 1005 may be a high-speed random access memory (RAM), or a stable non-volatile memory (NVM), such as a disk storage. The memory 1005 may also be a storage device independent of the aforementioned processor 1001.

Those skilled in the art will appreciate that the structure shown in FIG. 1 does not limit the in-vehicle remote controller, and may include more or fewer components than shown in the figure, or combine certain components, or arrange the components differently.

As shown in FIG. 1, the memory 1005 as a storage medium may include an operating system, a network communication module, a user interface module, and a program for controlling a remote controller.

In the in-vehicle remote controller shown in FIG. 1, the network interface 1004 is mainly used for data communication with the network server. The user interface 1003 is mainly used for data interaction with the user. The processor 1001 and the memory 1005 in the in-vehicle remote controller of the present application can be set in the in-vehicle remote controller, and the in-vehicle remote controller calls the program for controlling the remote controller stored in the memory 1005 through the processor 1001, and performs the following operations:
entering a sleep mode in response to a sleep command sent by a control terminal;
generating a wake-up command in response to a user operation sensed by the signal monitor; and
entering a wake-up mode according to the wake-up command.

In an embodiment, the operation of entering the wake-up mode according to the wake-up command includes:
increasing a data transmission frequency according to the wake-up command; and
sending a communication connection request to the control terminal based on the increased data transmission frequency.

In an embodiment, at least one physical button is provided at the in-vehicle remote controller, and the operation of generating the wake-up command in response to the user operation sensed by the signal monitor includes:
monitoring a button signal by the signal monitor, where the button signal is a signal generated after a physical button of the in-vehicle remote controller is triggered; and
in response to the button signal being greater than a preset button signal threshold, determining that the physical button is triggered and generating the wake-up command.

In an embodiment, at least one inductive sensor is provided in the in-vehicle remote controller, and the inductive sensor is used to monitor whether the in-vehicle remote controller is touched by the user. The operation of generating the wake-up command in response to the user operation sensed by the signal monitor includes:
monitoring a sensing signal collected by the inductive sensor through the signal monitor; and
in response to the sensing signal being greater than a preset sensing signal threshold, determining that the in-vehicle remote controller is touched by the user and generating the wake-up command.

In an embodiment, the inductive sensor includes at least one of a contact sensor and a non-contact sensor.

In an embodiment, the in-vehicle remote controller is electrically connected to a vehicle and is powered by the vehicle when the vehicle is powered on. The operation of generating the wake-up command in response to the user operation sensed by the signal monitor includes:
monitoring a charging signal by the signal monitor; and
in response to the charging signal being greater than a preset charging signal threshold, determining that the vehicle is powered on and generating the wake-up command.

Based on the above structure, various embodiments of the method for controlling the remote controller are provided.

As shown in FIG. 2, which is a flowchart of a method for controlling the remote controller according to an embodiment of the present application.

In this embodiment, the execution subject of the method for controlling the remote controller can be an in-vehicle remote controller, specifically, it can be a functional module in the in-vehicle remote controller, for example, a signal monitor, or other low-power functional modules, which is not limited in this embodiment. For the sake of convenience, the following description of each embodiment is omitted. In this embodiment, the in-vehicle remote controller includes: a signal monitor, and the method for controlling the remote controller includes:
step S10, entering a sleep mode in response to a sleep command sent by a control terminal.

The in-vehicle remote controller can be a separate newly added physical device, on which at least one button is provided, and the button can be a virtual button or a physical button. The in-vehicle remote controller can also be a device that adds corresponding software and hardware modules to existing devices (for example, mobile phones, watches, headphones, electric energy, tablets, etc.) to achieve command sending. The in-vehicle remote controller is used to respond to user operations. For example, the user triggers the button set on the in-vehicle remote controller; and then sends control instructions corresponding to the user operation to the control terminal, so as to interact with various in-vehicle devices set on the vehicle. The in-vehicle devices can be the air conditioner, audio and video entertainment system, seats, trunk, sunroof, windows, etc. on the vehicle. Through the in-vehicle remote controller, the user can interact with various in-vehicle devices of the vehicle at any position on the vehicle, so that the interaction between the user and the in-vehicle device is no longer limited to their location, which greatly improves the convenience of interaction.

The control terminal may be a local device installed on the vehicle, such as the vehicle's central control system, electronic control unit (ECU), etc. The control terminal may be connected to each in-vehicle device in the vehicle through the vehicle's controller area network (CAN) bus, thereby controlling each in-vehicle device to respond to user operations. The control terminal may also obtain various information about the vehicle, thereby generating a sleep command at an appropriate time and sending it to the in-vehicle remote controller. The control terminal may also be a mobile terminal such as a mobile phone or a computer, or a network device, which is not limited in this embodiment.

It should be understood that the method for controlling the remote controller of this embodiment can be applied to a system for controlling the remote controller, including: an in-vehicle remote controller and a control terminal, and the method is applied to an in-vehicle scene. The in-vehicle remote controller is used to control various in-vehicle devices on the vehicle, and each in-vehicle device needs to be powered on by the vehicle generator before it can be used. Therefore, if the vehicle is powered off, the in-vehicle device cannot be used without power, and the user no longer needs to use the in-vehicle remote controller, so the in-vehicle remote controller can enter sleep mode at this time. After the vehicle is powered on, there is a high probability that there are users on the vehicle, that is, there is a need to use the in-vehicle remote controller, so the in-vehicle remote controller needs to be in working state. In conventional remote controller usage scenarios, for example, home appliances (air conditioners, TVs, etc.) remote controller scenarios, users have long and scattered needs for the use of remote controllers, that is, there may be needs for use at any time, so it is difficult to set a specific time in this scenario to keep the remote controller in sleep mode for a long time. It is also necessary to wake up the remote controller regularly, or in sleep mode, part of the data processing capabilities of the remote controller is retained, and precise calculations are performed on the received signals. Although this can improve the wake-up accuracy of the remote controller, it will inevitably cause greater power consumption. The in-vehicle scenario is different from the conventional remote controller usage scenario. The user's demand for the use of the remote controller in this scenario is relatively short and concentrated, that is, the need to use the remote controller only exists after the vehicle is powered on, and this demand disappears after the vehicle is powered off. Therefore, the present application is based on the in-vehicle scenario, through the interaction between the in-vehicle remote controller and the control terminal in the remote controller control system, to achieve reasonable sleep and wake-up of the in-vehicle remote controller, while ensuring user use, reducing the overall power consumption of the in-vehicle remote controller, thereby increasing the battery life of the in-vehicle remote controller and achieving long-term battery life.

In an embodiment, the control terminal is communicated with the in-vehicle remote controller; the control terminal can determine whether to put the in-vehicle remote controller into sleep mode by obtaining information about the vehicle and the in-vehicle remote controller. For example, when the control terminal recognizes that the vehicle is powered off, the vehicle is locked, and the in-vehicle remote controller has not been used for a long time, it determines that the in-vehicle remote controller can enter sleep mode, thereby reducing unnecessary power consumption of the in-vehicle remote controller; after determining that the in-vehicle remote controller enters sleep mode, the control terminal generates a sleep command and sends the sleep command to the in-vehicle remote controller. After receiving the sleep command, the in-vehicle remote controller enters sleep mode in response to the sleep command.

In an embodiment, multiple functional modules can be provided in the in-vehicle remote controller, for example, a signal monitor for monitoring specific or general signals; a power module for power supply and power management; a communication module for establishing a communication connection with other terminals and communicating with them; and a main control chip for serving as a bridge between the various functional modules and controlling the operation of the in-vehicle remote controller.

In an embodiment, after the in-vehicle remote controller enters the sleep mode, the in-vehicle remote controller no longer performs wireless communication and other high-energy consumption calculations with the control terminal, thereby saving energy to the maximum extent and extending the battery life.

Step S20, generating a wake-up command in response to a user operation sensed by the signal monitor.

In an embodiment, after the in-vehicle remote controller enters the sleep mode, the signal monitor continues to monitor the signal. When a specific signal is detected, it is determined that the user's operation on the in-vehicle remote controller (i.e., user operation) is sensed, and a wake-up command is generated; the wake-up command can be an interrupt signal, which is used to wake up the in-vehicle remote controller from the sleep mode.

In an embodiment, after the in-vehicle remote controller enters sleep mode, only the signal monitor and the signal identification module work; the signal monitor continues to monitor the signal, and the signal identification module performs simple signal identification, for example, determining whether the monitored signal is greater than the response signal threshold; thereby achieving timely wake-up and ensuring user experience on the basis of reducing the operating power consumption of the in-vehicle remote controller as much as possible.

Step S30, entering a wake-up mode according to the wake-up command.

In an embodiment, according to the wake-up command, the wake-up mode is entered, that is, each functional module in the sleep state is awakened.

In an embodiment, after entering the wake-up mode, the in-vehicle remote controller immediately establishes a communication connection with the control terminal to ensure that the user can use the in-vehicle remote controller normally.

In this embodiment, by responding to the sleep command sent by the control terminal, the in-vehicle remote controller enters the sleep mode at an appropriate time, even if the high-power consumption functional modules (for example, the communication module, the high-precision calculation module, etc.) of the in-vehicle remote controller all enter the sleep state, thereby reducing the overall power consumption of the in-vehicle remote controller, and retaining the low-power consumption signal monitor of the in-vehicle remote controller to monitor specific signals. Then, in response to the user operation sensed by the signal monitor, a wake-up command is generated, and according to the wake-up command, the wake-up mode is entered, that is, the working state of the in-vehicle remote controller is restored; by reasonably dormant and waking up the in-vehicle remote controller, the overall power consumption of the in-vehicle remote controller is reduced while ensuring user use, thereby increasing the battery life of the in-vehicle remote controller and achieving long-term battery life.

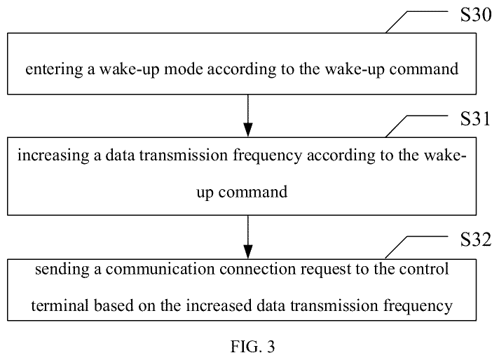

As shown in FIG. 3 in an embodiment, step S30, the step of entering the wake-up mode according to the wake-up command includes:

Step S31, increasing a data transmission frequency according to the wake-up command.

In an embodiment, the in-vehicle remote controller sends data based on a first preset frequency under normal working conditions to communicate with the control terminal; when the in-vehicle remote controller is in sleep mode, the communication connection between it and the control terminal is cut off. Therefore, after entering the wake-up mode, the in-vehicle remote controller needs to reconnect with the control terminal as soon as possible. In order to shorten the connection time between the in-vehicle remote controller and the control terminal, the data sending frequency of the in-vehicle remote controller is increased. For example, the data sending frequency of the in-vehicle remote controller is changed from the first preset frequency to the second preset frequency, where the second preset frequency is greater than the first preset frequency.

In an embodiment, the data sending frequency may be the number of times the communication connection request is sent within a unit time.

Step S32, sending a communication connection request to the control terminal based on the increased data transmission frequency.

In an embodiment, after increasing the data transmission frequency of the in-vehicle remote controller, the in-vehicle remote controller sends a communication connection request to the control terminal based on the increased data transmission frequency to achieve communication connection between the in-vehicle remote controller and the control terminal.

In an embodiment, after the in-vehicle remote controller is reconnected to the control terminal, the signal monitor may enter a sleep mode to reduce power consumption of the in-vehicle remote controller and extend battery life.

In an embodiment, after the in-vehicle remote controller and the control terminal are reconnected in communication, the data transmission frequency can be restored to the default frequency.

In this embodiment, the data sending frequency is increased according to the wake-up command; and then based on the increased data sending frequency, a communication connection request is sent to the control terminal to shorten the time required for reconnection between the in-vehicle remote controller and the control terminal, thereby minimizing the impact of sleep on the user's experience.

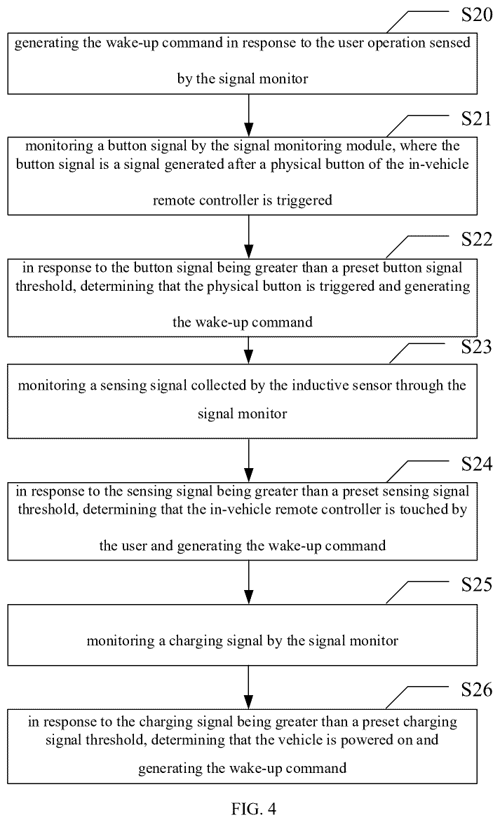

Based on the above embodiment, an embodiment of the method for controlling the remote controller of the present application is provided. In this embodiment, at least one physical button is provided at the in-vehicle remote controller. As shown in FIG. 4, in step S20, the step of generating the wake-up command in response to the user operation sensed by the signal monitor includes:

Step S21, monitoring a button signal by the signal monitor, where the button signal is a signal generated after a physical button of the in-vehicle remote controller is triggered.

In an embodiment, at least one physical button is provided at the in-vehicle remote controller; compared with the virtual button, the physical button can still be triggered by the user when the in-vehicle remote controller is in sleep mode. For example, the user presses the physical button; and after the physical button is triggered, a corresponding button signal can be generated. The signal monitor is configured to monitor the button signal.

Step S22, in response to the button signal being greater than a preset button signal threshold, determining that the physical button is triggered and generating the wake-up command.

In an embodiment, the signal monitor continuously monitors the button signal. When the button signal is greater than a preset button signal threshold, it determines that the physical button on the in-vehicle remote controller is triggered, that is, the user has a need to use the in-vehicle remote controller, and then generates a wake-up command to wake up the in-vehicle remote controller.

In an embodiment, as shown in FIG. 7, the in-vehicle remote controller includes: physical buttons, a main control chip, a signal monitor and an antenna for communication; the user wakes up the in-vehicle remote controller by triggering the physical button on the in-vehicle remote controller, that is, the signal monitor monitors the button signal generated after the physical button is triggered, and when the button signal is greater than the preset button signal threshold, it is determined that the physical button is triggered, and a wake-up command is generated to wake up the main control chip, antenna and other functional modules in the in-vehicle remote controller. And then a communication connection is established with the control terminal through the antenna.

In this embodiment, the signal monitor monitors the button signal generated after the physical key of the in-vehicle remote controller is triggered, and when the button signal is greater than the preset button signal threshold, it can be determined that the physical key is triggered, that is, the user has a need to use the in-vehicle remote controller, and then the wake-up command is generated to achieve rapid wake-up of the in-vehicle remote controller; by reasonably dormant and waking up the in-vehicle remote controller, the overall power consumption of the in-vehicle remote controller is reduced while ensuring user use, thereby increasing the battery life of the in-vehicle remote controller and achieving long-term battery life.

In an embodiment, at least one inductive sensor is provided in the in-vehicle remote controller, and the inductive sensor is used to monitor whether the in-vehicle remote controller is touched by the user. In step S20, generating the wake-up command in response to the user operation sensed by the signal monitor includes:

Step S23, monitoring a sensing signal collected by the inductive sensor through the signal monitor.

In an embodiment, at least one inductive sensor is provided in the in-vehicle remote controller, and the inductive sensor can monitor whether the in-vehicle remote controller is touched by the user; since the user must touch the in-vehicle remote controller when he needs to use the in-vehicle remote controller, the inductive sensor is provided on the in-vehicle remote controller, so that the user's intention can be monitored immediately and the in-vehicle remote controller can be awakened in time. The inductive signal collected by the inductive sensor is monitored by the signal monitor.

Step S24, in response to the sensing signal being greater than a preset sensing signal threshold, determining that the in-vehicle remote controller is touched by the user and generating the wake-up command.

In an embodiment, the signal monitor continuously monitors the sensing signal. When the sensing signal is greater than a preset sensing signal threshold, it is determined that the user has touched the in-vehicle remote controller, that is, the user has a need to use the in-vehicle remote controller, and then a wake-up command is generated to wake up the in-vehicle remote controller.

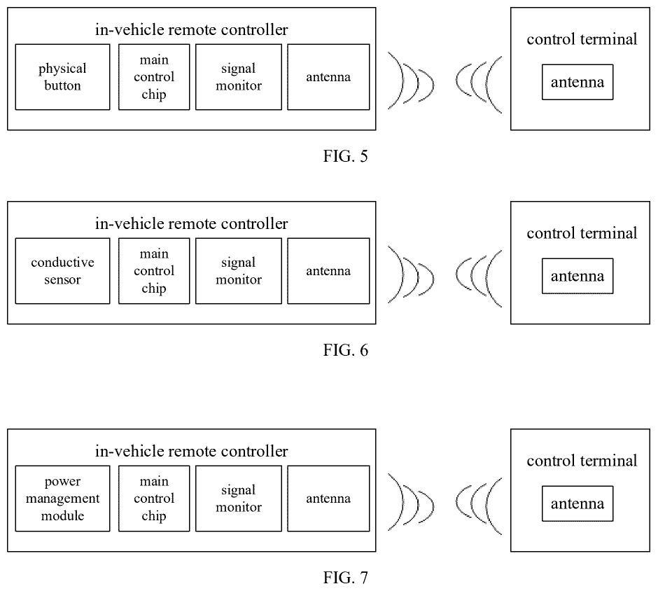

In an embodiment, as shown in FIG. 6, the in-vehicle remote controller includes: an inductive sensor, a main control chip, a signal monitor and an antenna for communication. The user wakes up the in-vehicle remote controller by touching the in-vehicle remote controller, that is, the signal monitor monitors the inductive signal collected by the inductive sensor when the user touches the in-vehicle remote controller, and when the inductive signal is greater than a preset inductive signal threshold, it is determined that the in-vehicle remote controller is touched by the user, and the wake-up command is generated to wake up the main control chip, antenna and other functional modules in the in-vehicle remote controller; and then a communication connection is established with the control terminal through the antenna.

In an embodiment, the inductive sensor includes: at least one of a contact sensor and a non-contact sensor.

A non-contact sensor refers to a sensor that does not need to contact the object being measured. It can measure the object being measured through physical quantities such as light, sound, electricity, and magnetism.

Contact sensors are sensors that need to contact the object being measured. They measure by contacting the object being measured and can be used to measure physical quantities such as force, temperature, and pressure. For example, thermocouples, strain gauges, and pressure sensors.

In an embodiment, the inductive sensor may include: a posture sensor, a temperature sensor, a capacitive proximity sensor, an inductive proximity sensor, a photoelectric proximity sensor, etc.

The attitude sensor may be an inertial sensor, including a gyroscope and an accelerometer; the angular velocity of the in-vehicle remote controller is sensed by the gyroscope, and the acceleration of the in-vehicle remote controller is sensed by the accelerometer. Both the angular velocity and the acceleration are attitude signals.

Capacitive proximity sensors, inductive proximity sensors, and photoelectric proximity sensors are all proximity sensors that can detect the movement and presence information of an object and convert it into a corresponding electrical signal (i.e., proximity signal).

A temperature sensor is a sensor that can sense temperature and convert it into a usable output signal (i.e., temperature signal).

In an embodiment, the sensing signal includes at least one of a posture signal, a proximity signal and a temperature signal.

In this embodiment, the signal monitor monitors the sensing signal collected by the sensing sensor provided in the in-vehicle remote controller; and when the sensing signal is greater than a preset sensing signal threshold, it is determined that the in-vehicle remote controller is touched by the user, that is, the user has a need to use the in-vehicle remote controller, and the wake-up command is issued to achieve rapid wake-up of the in-vehicle remote controller. By reasonably dormant and waking up the in-vehicle remote controller, the overall power consumption of the in-vehicle remote controller is reduced while ensuring user use, thereby increasing the battery life of the in-vehicle remote controller and achieving long-term battery life.

In an embodiment, the in-vehicle remote controller is electrically connected to the vehicle, and the vehicle supplies power to the in-vehicle remote controller when powered on. In step S20, the step of generating the wake-up command in response to the user operation sensed by the signal monitor includes:

Step S25, monitoring a charging signal by the signal monitor.

In an embodiment, the in-vehicle remote controller is electrically connected to the vehicle so that the vehicle can supply power to the in-vehicle remote controller when it is powered on; the electrical connection can be a wired electrical connection or a radio connection. Since the remote controller is used in a vehicle-mounted scenario, after the vehicle is powered off, the user may have left the vehicle and no longer have the need to interact with the various on-board devices on the vehicle. Therefore, the in-vehicle remote controller enters sleep mode in this scenario. After the vehicle is powered on, it indicates that the user has returned to the vehicle, and at this time the user may have the need to interact with the on-board devices on the vehicle again. Therefore, the charging signal is monitored by the signal monitor.

Step S26, in response to the charging signal being greater than a preset charging signal threshold, determining that the vehicle is powered on and generating the wake-up command.

In an embodiment, the signal monitor continuously monitors the charging signal, and when the charging signal is greater than a preset charging signal threshold, it determines that the vehicle is powered on, that is, the user has a need to use the in-vehicle remote controller, and then generates a wake-up command to wake up the in-vehicle remote controller.

In an embodiment, as shown in FIG. 7, the in-vehicle remote controller includes: a power management module, a main control chip, a signal monitor and an antenna for communication. The user can wake up the in-vehicle remote controller by powering on the vehicle, that is, the signal monitor monitors the charging signal of the power management module after the vehicle is powered on, and when the charging signal is greater than a preset charging signal threshold, it is determined that the vehicle is powered on, and the wake-up command is generated to wake up the main control chip, antenna and other functional modules in the in-vehicle remote controller; and then a communication connection is established with the control terminal through the antenna.

In this embodiment, the charging signal is monitored by the signal monitor; when the charging signal is greater than a preset charging signal threshold, it is determined that the vehicle is powered on, that is, the user has a need to use the in-vehicle remote controller, and the wake-up command is issued to quickly wake up the in-vehicle remote controller. By reasonably dormant and waking up the in-vehicle remote controller, the overall power consumption of the in-vehicle remote controller is reduced while ensuring user use, thereby increasing the battery life of the in-vehicle remote controller and achieving long-term battery life.

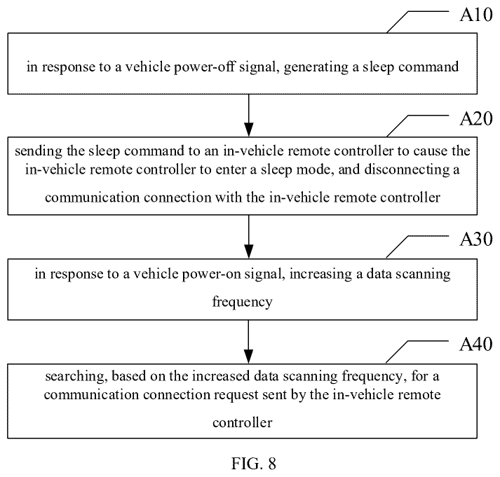

In an embodiment, the present application further provides a method for controlling the remote controller, which is applied to a control terminal. In this embodiment, the execution subject of the method for controlling the remote controller may be a control terminal, and the control terminal may be a local device, such as a vehicle's central control system, an ECU, etc. It may also be a mobile terminal such as a mobile phone or a notebook, or a network device, which is not limited in this embodiment. For ease of description, the following description of each embodiment is omitted for the execution subject. As shown in FIG. 8, in this embodiment, the method for controlling the remote controller includes:

Step A10, in response to a vehicle power-off signal, generating a sleep command.

In an embodiment, the vehicle generates a vehicle power-off signal after the user turns off the generator, or the vehicle is locked, or the vehicle is locked for a preset time; and then generates a sleep command in response to the vehicle power-off signal.

Step A20, sending the sleep command to an in-vehicle remote controller to cause the in-vehicle remote controller to enter a sleep mode, and disconnecting a communication connection with the in-vehicle remote controller.

In an embodiment, a sleep command is sent to a matching in-vehicle remote controller, so that the in-vehicle remote controller enters a sleep mode and disconnects the communication connection with the in-vehicle remote controller.

In this embodiment, a sleep command is generated in response to a vehicle power-off signal; the sleep command is then sent to the in-vehicle remote controller to put the in-vehicle remote controller into sleep mode and disconnect the communication connection with the in-vehicle remote controller. By allowing the in-vehicle remote controller enter the sleep mode at an appropriate time, even if the high-power consumption functional modules of the in-vehicle remote controller (for example, the communication module, the high-precision calculation module, etc.) all enter the sleep state, the overall power consumption of the in-vehicle remote controller is reduced and the battery life of the in-vehicle remote controller is improved.

In an embodiment, after the step of disconnecting the communication connection with the in-vehicle remote controller in step A20, the method further includes:

Step A30, in response to a vehicle power-on signal, increasing a data scanning frequency.

In an embodiment, after the user starts the engine of the vehicle, the vehicle generates a vehicle power-on signal; in response to the vehicle power-on signal, the data scanning frequency is increased; the control terminal performs data scanning based on a third preset frequency under normal working conditions, thereby communicating with the in-vehicle remote controller. While the in-vehicle remote controller will cut off the communication connection between it and the control terminal when it is in sleep mode, so the in-vehicle remote controller needs to reconnect with the control terminal as soon as possible after entering the wake-up mode. In order to shorten the connection time between the in-vehicle remote controller and the control terminal, the data scanning frequency of the control terminal can be increased. For example, the data scanning frequency of the control terminal is changed from the third preset frequency to the fourth preset frequency, where the fourth preset frequency is greater than the third preset frequency.

In an embodiment, the data scanning frequency may be the number of scans or searches of data per unit time.

Step A40, searching, based on the increased data scanning frequency, for a communication connection request sent by the in-vehicle remote controller.

In an embodiment, after increasing the data scanning frequency of the control terminal, the control terminal searches for the communication connection request sent by the in-vehicle remote controller based on the increased data scanning frequency to achieve the communication connection between the in-vehicle remote controller and the control terminal.

In an embodiment, after the in-vehicle remote controller is reconnected to the control terminal, the data scanning frequency may be restored to the default frequency.

In this embodiment, in response to the vehicle power-on signal, the data scanning frequency is increased; then, based on the increased data scanning frequency, the communication connection request sent by the in-vehicle remote controller is searched to shorten the time required for reconnection between the in-vehicle remote controller and the control terminal, thereby minimizing the impact of the in-vehicle remote controller sleep state on the user's experience.

Furthermore, the embodiment of the present application further provides a system for controlling the remote controller, including: an in-vehicle remote controller and a control terminal, the in-vehicle remote controller and the control terminal are communicatively connected.

The in-vehicle remote controller is configured to enter a sleep mode in response to a sleep command sent by the control terminal; generate a wake-up command in response to a user operation sensed by a signal monitor; and enter a wake-up mode according to the wake-up command.

The control terminal is configured to generate a sleep command in response to a vehicle power-off signal; send the sleep command to the in-vehicle remote controller to cause the in-vehicle remote controller to enter the sleep mode; and disconnect the communication connection with the in-vehicle remote controller.

In an embodiment, the in-vehicle remote controller is further configured to increase a data transmission frequency according to the wake-up command; and send a communication connection request to the control terminal based on the increased data transmission frequency.

In an embodiment, the in-vehicle remote controller is further configured to monitor a button signal by the signal monitor, where the button signal is a signal generated after a physical button of the in-vehicle remote controller is triggered; in response to the button signal being greater than a preset button signal threshold, determine that the physical button is triggered and generating the wake-up command.

In an embodiment, the in-vehicle remote controller is further configured to monitor a sensing signal collected by the inductive sensor through the signal monitor; and in response to the sensing signal being greater than a preset sensing signal threshold, determine that the in-vehicle remote controller is touched by the user and generating the wake-up command.

In an embodiment, the in-vehicle remote controller is further configured to monitor a charging signal by the signal monitor; and in response to the charging signal being greater than a preset charging signal threshold, determine that the vehicle is powered on and generating the wake-up command.

In an embodiment, the control terminal is further configured to increase the data scanning frequency in response to a vehicle power-on signal; and based on the increased data scanning frequency, search for a communication connection request sent by the in-vehicle remote controller.

The specific implementation of the system for controlling the remote controller of the present application is basically the same as the embodiments of the method for controlling the remote controller described above, and will not be repeated here.

It should be noted that, in this article, the terms “include”, “comprises” or any other variations thereof are intended to cover non-exclusive inclusion, so that a process, method, article or system including a series of elements includes not only those elements, but also other elements not explicitly listed, or further includes elements inherent to such process, method, article or system. In the absence of further restrictions, an element defined by the sentence “comprises a . . . ” does not exclude the existence of other identical elements in the process, method, article or system including the element.

Through the description of the above implementation methods, those skilled in the art can clearly understand that the above-mentioned embodiment methods can be implemented by means of software plus a necessary general hardware platform, and of course by hardware, but in many cases the former is a better implementation method. Based on such an understanding, the technical solution of the present application is essentially or the part that contributes to the prior art can be embodied in the form of a software product, which is stored in a storage medium (such as ROM/RAM, magnetic disk, optical disk) as described above, and includes a number of instructions for a terminal device (which can be a mobile terminal, a computer, a server, or a network device, etc.) to execute the methods described in each embodiment of the present application.

The above are only some embodiments of the present application, and do not limit the scope of the present application thereto. Under the inventive concept of the present application, equivalent structural transformations made based on the description and drawings of the present application, or direct/indirect application in other related technical fields are included in the scope of the present application.

What is claimed is:

1. A method for controlling a remote controller, applied to an in-vehicle remote controller comprising a signal monitor, the method comprising:
entering a sleep mode in response to a sleep command sent by a control terminal;
generating a wake-up command in response to a user operation sensed by the signal monitor; and
entering a wake-up mode according to the wake-up command.

2. The method according to claim 1, wherein the entering the wake-up mode according to the wake-up command comprises:
increasing a data transmission frequency according to the wake-up command; and
sending a communication connection request to the control terminal based on the increased data transmission frequency.

3. The method according to claim 1, wherein the in-vehicle remote controller comprises at least one physical button, and the generating the wake-up command in response to the user operation sensed by the signal monitor comprises:
monitoring a button signal by the signal monitor, wherein the button signal is a signal generated after a physical button of the in-vehicle remote controller is triggered; and
in response to the button signal being greater than a preset button signal threshold, determining that the physical button is triggered and generating the wake-up command.

4. The method according to claim 1, wherein the in-vehicle remote controller comprises at least one inductive sensor configured to monitor whether the in-vehicle remote controller is touched by a user, and the generating the wake-up command in response to the user operation sensed by the signal monitor comprises:
monitoring a sensing signal collected by the inductive sensor through the signal monitor; and
in response to the sensing signal being greater than a preset sensing signal threshold, determining that the in-vehicle remote controller is touched by the user and generating the wake-up command.

5. The method according to claim 4, wherein the inductive sensor comprises at least one of a contact sensor and a non-contact sensor.

6. The method according to claim 1, wherein the in-vehicle remote controller is electrically connected to a vehicle and is powered by the vehicle when the vehicle is powered on, and the generating the wake-up command in response to the user operation sensed by the signal monitor comprises:
monitoring a charging signal by the signal monitor; and
in response to the charging signal being greater than a preset charging signal threshold, determining that the vehicle is powered on and generating the wake-up command.

7. A method for controlling a remote controller, applied to a control terminal, the method comprising:
in response to a vehicle power-off signal, generating a sleep command; and
sending the sleep command to an in-vehicle remote controller to cause the in-vehicle remote controller to enter a sleep mode, and disconnecting a communication connection with the in-vehicle remote controller.

8. The method according to claim 7, wherein after the disconnecting the communication connection with the in-vehicle remote controller, the method further comprises:
in response to a vehicle power-on signal, increasing a data scanning frequency; and
searching, based on the increased data scanning frequency, for a communication connection request sent by the in-vehicle remote controller.

9. A system for controlling a remote controller, comprising an in-vehicle remote controller and a control terminal communicated with the in-vehicle remote controller, wherein:
the in-vehicle remote controller is configured to enter a sleep mode in response to a sleep command sent by the control terminal; generate a wake-up command in response to a user operation sensed by a signal monitor; and enter a wake-up mode according to the wake-up command; and
the control terminal is configured to generate a sleep command in response to a vehicle power-off signal; send the sleep command to the in-vehicle remote controller to cause the in-vehicle remote controller to enter the sleep mode; and disconnect the communication connection with the in-vehicle remote controller.

10. An in-vehicle remote controller, comprising a memory, a processor, and a program for controlling a remote controller stored in the memory and executable on the processor, wherein the program for controlling the remote controller is configured to implement the method for controlling the remote controller according to claim 1.

11. A control terminal, comprising a memory, a processor, and a program for controlling a remote controller stored in the memory and executable on the processor, wherein the program for controlling the remote controller is configured to implement the method for controlling the remote controller according to claim 7.

12. A non-transitory computer-readable storage medium, on which a program for controlling a remote controller is stored, wherein when the program for controlling the remote controller is executed by a processor, the method for controlling the remote controller according to claim 1 is implemented.

13. A non-transitory computer-readable storage medium, on which a program for controlling a remote controller is stored, wherein when the program for controlling the remote controller is executed by a processor, the method for controlling the remote controller according to claim 7 is implemented.
